(19) United States
(12) Patent Application Publication
(10) Pub. No.: US 2009/0285989 A1
(43) Pub. Date: Nov. 19, 2009

(54) Dispersion, Ink, Process, Use and Dispersant

(76) Inventors: Owen Roger Lozman, Blackley (GB); Richard Thomas Williams, Blackley (GB)

Correspondence Address: MORGAN LEWIS & BOCKIUS LLP, 1111 PENNSYLVANIA AVENUE NW, WASHINGTON, DC, 20004, US

(21) Appl. No.: 12/435,445

(22) Filed: May 5, 2009

(30) Foreign Application Priority Data
May 14, 2008 (GB) 0808700.9

(51) Int. Cl. B05D 5/06; C08L 43/00; C08F 30/06

(52) U.S. Cl. 427/256; 524/547; 526/239

(57) ABSTRACT

An aqueous dispersion comprising water, pigment particles and a polymeric dispersant comprising monomer repeat units from polymerising one or more ethylenically unsaturated monomers, said dispersant having one or more boronic acid groups. The dispersion is useful for preparing ink jet printing inks having improved durability and highlighter smear fastness when printed onto paper.

### FIELD

This invention relates to aqueous pigment dispersions and especially, but not limited to, aqueous pigment dispersions suitable for making ink jet printing (IJP) inks. The present invention also relates to an ink jet printing process, to the use of this process and to dispersants.

### BACKGROUND

There are many demanding performance requirements for IJP inks and especially pigment-based ink jet printing inks. In particular, it is desirable that pigment-based IJP inks can provide prints which exhibit a high reflectance optical density and which are durable, for example resistant to wet or dry abrasion.

In addition, it is desirable that the IJP inks are stable over long periods of time both during storage and during printing. If such stability is not present to a sufficiently degree then the print quality may be adversely affected. A reduction in print quality can be seen by, for example, by missing lines or bands in the final printed image. In extreme cases the ink jet printer nozzles may become substantially or entirely blocked leading to very poor printing indeed. Pigment-based IJP inks tend to have markedly different stability behaviour when compared to dye-based IJP inks. Whilst not wishing to be limited by theory it is often speculated that the greater difficulty in achieving suitable stability with pigment-based inks is a result of the difficulty in preventing the pigment particles from aggregating or flocculating over time. In complete contrast, in dye-based inks the dye is dissolved (not dispersed) in the ink and accordingly aggregation and flocculation problems are much less significant.

Accordingly, there is a need to provide aqueous dispersions which can be used to prepare inks and especially IJP inks having one or more of the desirable properties mentioned above.

JP 2007/277302 discloses aqueous pigment-based IJP inks which contain low molecular weight (non polymeric) dispersants containing boronic acid groups.

We have surprisingly found that certain polymeric dispersants containing boronic acid groups can be used to prepare aqueous pigment-based dispersions, inks and especially IJP inks which provide one or more of the aforementioned advantages.

According to a first aspect of the present invention there is provided an aqueous dispersion comprising waters pigment particles and a polymeric dispersant comprising monomer repeat units from polymerising one or more ethylenically unsaturated monomers, said dispersant having one or more boronic acid groups.

### Definitions

As used herein and unless otherwise stated the word “a” means “one or more”. Thus, for example, a polymeric dispersant means one or more polymeric dispersants.

### Pigment Particles

The pigment in the pigment particles may be inorganic or organic. Pigments are essentially insoluble in liquids such as water and acetone. Preferred organic pigments include, for example any of the classes of pigments described in the Colour Index International, Third Edition, (1971) and subsequent revisions of, and supplements thereto, under the chapter headed “Pigments”.

Examples of organic pigments are those from the azo (including disazo and condensed azo), thioindigo, indanthrone, isoindanthrone, anthanthrone, anthraquinone, isodibenzanthrone, triphendioxazine, quinacridone and phthalocyanine series, especially copper phthalocyanine and its nuclear halogenated derivatives, and also lakes of acid, basic and mordant dyes. Preferred organic pigments are phthalocyanine pigments, especially copper phthalocyanine pigments, azo pigments, indanthrone, anthanthrone, quinacridone pigments.

Preferred inorganic pigments include carbon black, titanium dioxide, aluminium oxide, iron oxide and silicon dioxide.

In the case of carbon blacks these may be prepared in such a fashion that some of the carbon black surface has oxidized groups (e.g. carboxy and/or hydroxy groups). However, the amount of such groups is preferably not so high that the carbon black is dispersible in water at 20° C. without the aid of a dispersant.

Preferably, the pigment is a cyan, magenta, yellow or black pigment or a mixture comprising two or more of the same.

The pigment may be a single chemical species or a mixture comprising two or more chemical species (e.g. a mixture comprising two or more different pigments). Preferably, the pigment is not dispersible in water at 20° C. without the aid of a dispersant. Preferably, the pigment has not been surface treated so as to have ionic groups covalently bonded to its surface (for example carboxy or sulpho groups).

The pigment particles preferably have an average particle size of less than 1 micron, more preferably from 50 nm to 500 nm and especially from 50 nm to 300 nm. The average particle size is preferably measured by a light scattering technique. The average particle size is preferably a volume or z-average size. For IJP inks in particular such small particle sizes are highly desirable.

### Encapsulated Pigments

Optionally, the polymeric dispersant is cross-linked around the pigment particles so as to encapsulate each pigment particle. These are hereinafter referred to as “encapsulated pigments”.

Preferably, such encapsulated pigments are prepared by cross-linking the polymeric dispersant in the presence of the pigment particles and water. Preferred encapsulated pigments of this type are described in PCT patent publication WO 2006/064193.

Encapsulated pigments are preferred because they are more colloidally stable than the un-crosslinked equivalents. Thus, further improvements in storage and printer stability can be achieved. Additionally, the encapsulated pigments may be formulated into inks containing higher levels of organic solvents whilst better resisting the tendency to flocculate or aggregate.

### Dispersion

The term aqueous as used herein means those dispersions comprising at least some water, it does not imply any particular amount of water.

Preferably, the dispersion comprises at least 10% by weight, more preferably at least 20% and especially at least 30% by weight of water relative to all of the liquids present in the dispersion. When the aqueous dispersions are to be used to prepare IJP inks it is preferred that the dispersion comprises at least 50% by weight, more preferably at least 70% by weight and especially preferably at least 90% by weight of water relative to all of the liquids present in the dispersion.

In addition to water the dispersion may contain one or more organic liquids. Preferred organic liquids are water-miscible organic liquids. Suitable organic liquids include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol polyethylene glycol, propylene glycol, dipropylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulphoxides, preferably dimethyl sulphoxide and sulpholane.

Preferably, the aqueous dispersion comprises water and 2 or more, especially from 2 to 8, water-miscible organic liquids.

Especially preferred water-miscible organic liquids for the ink are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol, triethyleneglycol, propylene glycol and dipropylene glycol; and mono-C₁₋₄-alkyl and di-C₁₋₄-alkyl ethers of diols, more preferably mono-C₁₋₄-alkyl ethers of diols having 2 to 12 carbon atoms, especially 2-methoxy-2-ethoxy-2-ethoxyethanol.

### Water

The water present in the dispersion is preferably purified water, for example water obtained by reverse osmosis, deionisation and/or distillation.

### Polymeric Dispersant

### Boronic Acid Groups

It will be understood that a boronic acid group is of the formula —B(OH)₂ wherein the boron atom is bonded to a carbon atom in the dispersant molecule.

Preferably, each boronic acid group is directly bonded to a carbon atom in an aliphatic, heterocyclic or more preferably an aromatic group which is present in the polymeric dispersant structure. Two or more boronic acid groups may be bonded to a single aliphatic, heterocyclic or aromatic group. Preferably, no aliphatic, heterocyclic or aromatic group present in the dispersant has more than two, more preferably more than one boronic acid group.

The polymeric dispersant may have mixtures of different kinds of boronic acid groups some of which are bonded to, for example, an aliphatic group and some which are bonded to an aromatic group, however, it is more preferred that all of the boronic acid groups present in the polymeric dispersant are bonded to aromatic groups.

### Boronic Acid Groups Bonded to Aliphatic Groups in the Dispersant

When one or more boronic acid groups are bonded to an aliphatic group the aliphatic group is preferably a C₁₋₃₀ aliphatic group. The C₁₋₃₀ aliphatic group may be substituted with one or more further substituents. More preferably, the C₁₋₃₀ aliphatic group is unsubstituted. The boronic acid groups may be bonded to any one or more of the carbon atoms in the C₁₋₃₀ aliphatic group. Preferably, the C₁₋₃₀ aliphatic group is a C₁₋₃₀ alkyl group. Preferably, the C₁₋₃₀ alkyl boronic acid group is of the Formula —(CH₂)ₙB(OH)₂ wherein n is from 1 to 30, more preferably from 1 to 12.

### Boronic Acid Groups Bonded to Heterocyclic Groups in the Dispersant

When one or more boronic acid groups are bonded to a heterocyclic group the heterocyclic group may be polycyclic (e.g. benzothiophenyl) or monocyclic (e.g. thiophenyl) group. Preferably, the heterocyclic group comprises one or more rings at least one of which contains one or more heteroatoms selected from N, S and O. The heterocyclic group preferably comprises one or more 5- and/or 6-membered rings. The heterocyclic group may be substituted with one or more further substituents. Preferably, the heterocyclic group has no further substituents. Examples of heterocyclic groups include furan, benzofuran, isobenzofuran, pyrrole, indole, isoindole, thiophene, benzothiophene, benzo[c]thiophene, imidazole, benzimidazole, purine, pyrazole, indazole, oxazole, benzoxazole, isoxazole, benzisoxazole, thiazole and benzothiazole subgroups. Of these thiophene is especially preferred. Preferably, the heterocyclic group is a heteroaryl group.

### Boronic Acid Groups Bonded to Aromatic Groups in the Dispersant

When one or more boronic acid groups are bonded to an aromatic group, the aromatic group may be polycyclic (e.g. naphthylene) but is more preferably mono cyclic (e.g. phenylene). The aromatic group may be substituted with one or more further substituents. Preferably, the aromatic group has no further substituents. Examples of aromatic groups include anthracene, naphthalene, phenanthrene and especially benzene. Preferably, the aromatic group is an aryl group, which is most preferably phenyl. Thus, a preferred dispersant has phenyl boronic acid groups.

### Optional Further Substituents

Further substituents which may be present in the aliphatic, heterocyclic or aromatic groups are preferably selected from the group consisting of halo (especially F, Cl, and Br), nitro, cyano, amine, amide (especially urea), ether, ester, sulfo (—SO₃H), carboxy (—CO₂H), phosphate (—PO₃H₂), thiol and thio ether.

### One or More Ethylenically Unsaturated Monomers

Preferred ethylenically unsaturated monomers polymerised to form the polymeric dispersant include styrenic and especially acrylic and methacrylic monomers. Thus, the preferred polymeric dispersants comprise one or more monomer repeat units from the polymerisation of these monomers.

### General Characteristic of the Polymeric Dispersant

The polymeric dispersants are preferably random polymers (e.g. having statistically short blocks or segments) but can be block or graft polymers (e.g. having longer blocks or segments). Polymeric dispersants may have two or more segments but are preferably random.

When the polymeric dispersant has two or more segments it is preferred that at least one segment is hydrophobic and at least one segment is hydrophilic relative to each other.

Preferably, the polymeric dispersant additionally has acid groups, other than boronic acid groups. Preferably, these acid groups are phoso (—PO₃H₂), sulfo (—SO₃H) and especially carboxy (—CO₂H). The acid groups other than boronic acid may be in the form of the free acid or in the form of the salt. It is preferred that the polymeric dispersant has a ratio of moles of acid groups other than boronic acid to boronic acid groups of from 30:1 to 1:10, more preferably from 10:1 to 1:5 and especially from 7:1 to 1:1. Preferably, the dispersant has from 1 to 6 mmoles, more preferably from 2 to 4 mmoles of acid groups other than boronic acid per g of polymeric dispersant.

Preferably, the polymeric dispersant has a number average molecular weight of from 1,000 to 1,000,000, more preferably from 1,000 to 50,000 and especially from 1,000 to 35,000. Preferably, this is measured by Gel permeation chromatography (GPC) using polystyrene standards.

It is preferred that the polymeric dispersant comprises monomer repeat units from polymerising both hydrophobic and hydrophilic ethylenically unsaturated monomers.

### Preferred Polymeric Dispersants

Preferably, the polymeric dispersant comprises monomer repeat units from polymerising the components:
i) one or more hydrophilic ethylenically unsaturated monomers, all of which have no boronic acid groups;
ii) one or more hydrophobic ethylenically unsaturated monomers, all of which have no boronic acid groups; and
iii) one or more ethylenically unsaturated monomers each of which has one or more boronic acid group.

### i) Hydrophilic Monomers

Hydrophilic ethylenically unsaturated monomers suitable for component i) are those comprising hydrophilic groups which may be ionic or non-ionic groups, but excluding boronic acid groups. It is sometimes useful to calculate the Log P value of a given monomer. In rare marginal cases we prefer to consider those monomers having a calculated Log P of more than 1.0 to be hydrophobic and those having a Log P value equal to or less than 1.0 to be hydrophilic. A review by Mannhold, R. and Dross, K. (Quant. Struct-Act. Relat. 15, 403-409, 1996) describes 14 methods for calculating Log P values of compounds and especially drugs. From this review we prefer the “fragmental methods” and especially the fragmental method implemented by ACD labs software.

The calculated Log P of a dispersant may be calculated using commercially available computer software, for example using the Log P DB software version 7.04 or a later version of such software (which is available from Advanced Chemistry Development Inc (ACD labs)). Any ionic or ionisable groups are calculated in their neutral (unionised) form.

Thus, for example the repeat unit from polymerising methacrylic acid has an ACD Labs calculated Log P value of 0.83 (in the unionised form) and is therefore considered to be hydrophilic. In contrast, the repeat unit from polymerising methyl methacrylate has an ACD Labs calculated Log P value of 1.35 and is therefore considered to be hydrophobic.

The ionic groups may be cationic but are preferably anionic. Both cationic and anionic groups may be used to give an amphoteric polymeric dispersant. Preferred anionic groups are acid groups (other than boronic acid), in particular sulphonic acid, phosphonic acid and especially carboxylic acid groups which may be in the free acid or salt form. Preferred salts forms are ammonium, substituted ammonium, quaternary ammonium, sodium, lithium and potassium salts.

Preferred cationic groups are substituted ammonium, quaternary ammonium, benzalkonium, guanidine, biguanidine and pyridinium. These can be in the form of a free base or a salt (e.g. a hydroxide, sulphate, nitrate, chloride, bromide, iodide or fluoride salt or in the form of a quaternary ammonium salt formed with for example an alkyl halide or dimethyl sulphate).

Preferred non-ionic groups are polypyrrolidone, polyacrylamide groups and especially alkyl terminated polyethyleneoxy groups.

Preferred hydrophilic ethylenically unsaturated monomers are acrylic acid, methacrylic acid, itaconic acid, β-carboxy ethyl acrylate, maleic acid, monoalkyl itaconates (for example, monomethyl maleate, monoethyl maleate, monobutyl maleate and monooctyl maleate), citraconic acid, styrenesulfonic acid, vinylbenzylsulfonic acid, vinylsulfonic acid, acryloyloxyalkyl sulfonic acids (for example, acryloyloxymethyl sulfonic acid, acryloyloxyethyl sulfonic acid, acryloyloxypropyl sulfonic acid and acryloyloxybutyl sulfonic acid), methacryloyloxymethyl sulfonic acid, methacryloyloxyethyl sulfonic acid, methacryloyloxypropyl sulfonic acid and methacryloyloxybutyl sulfonic acid), 2-acrylamido-2-alkylalkane sulfonic acids (for example, 2-acrylamido-2-methylethanesulfonic acid, 2-acrylamido-2-methylpropanesulfonic acid and 2-acrylamido-2-methylbutane sulfonic acid), 2-methacrylamido-2-alkylalkane sulfonic acids (for example, 2-methacrylamido-2-methylethanesulfonic acid, 2-methacrylamido-2-methylpropanesulfonic acid and 2-methacrylamido-2-methylbutanesulfonic acid), mono-(acryloyloxyalkyl)phosphates (for example, mono(acryloyloxyethyl)phosphate and mono(3-acryloyloxypropyl)phosphates) and mono(methacryloyloxyalkyl)phosphates (for example, mono(methacryloyloxyethyl )phosphate, mono(3-methacryloyloxypropyl)phosphate), mono alkyl terminated polyethyleneoxy monoacrylates and monomethacrylates.

Of these, methacrylic acid is particularly preferred.

### ii) Hydrophobic Monomers

Hydrophobic ethylenically unsaturated monomers suitable for component ii) are those comprising hydrophobic groups and which have no boronic acid groups. Preferred hydrophobic groups are predominantly hydrocarbons, fluorocarbons and alkyl siloxanes comprising less than three and more preferably no hydrophilic groups. The hydrophobic group is preferably a C₁₋₅₀ chain or ring which can be pendant or in chain with the hydrophobic monomer.

Preferred hydrophobic ethylenically unsaturated monomers include C₁₋₂₀-hydrocarbyl(meth)acrylates, butadiene, styrene and vinyl naphthalene. Especially preferred C₁₋₂₀-hydrocarbyl(meth)acrylates are methyl methacrylate, butyl(meth)acrylate, octyl (meth)acrylate, 2-ethyl hexyl(meth)acrylate, isobornyl acrylate, lauryl acrylate, and stearyl acrylate. Other preferred hydrophobic vinyl monomers are the poly propyleneoxy(meth)acrylates and polybutyleneoxy(methacrylates) which are alky (e.g. methyl) end-capped. Of these, 2-ethyl hexyl(meth)acrylate, butyl(meth)acrylate, methyl methacrylate and styrene are preferred. In some embodiments it is preferred that the hydrophobic monomers in component ii) comprise or consist of both methyl methacrylate and one or more monomers selected from 2-ethyl hexyl(meth)acrylate, butyl(meth)acrylate and styrene.

iii) Ethylenically Unsaturated Monomers Having One or More Boronic Acid Groups

Ethylenically unsaturated monomers containing one or more boronic acid groups suitable for component iii) are preferably (meth)acrylate or styrenic monomers. The monomers for component iii) may be hydrophilic but are preferably hydrophobic.

Preferably, these monomers have only one or two, more preferably only one boronic acid group. Preferably, the boronic acid groups are attached to a heterocyclic, or more preferably an aromatic group in the monomer. Preferred monomers having boronic acid groups are of the Formulae (1) to (6):

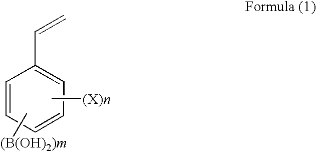

wherein each X independently is a further substituent as hereinbefore described, n is from 0 to 2 (preferably 0) and m is from 1 to 2 (preferably 1).

A particularly preferred monomer of Formula (1) is 4-vinyl phenyl boronic acid.

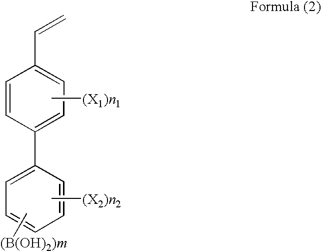

wherein each X₁ and X₂ independently is a further substituent as hereinbefore described and n₁ and n₂ are each independently from 0 to 2 (both preferably 0) and m is 1 or 2 (preferably 1).

A preferred monomer of Formula (2) is of the Formula (2a):

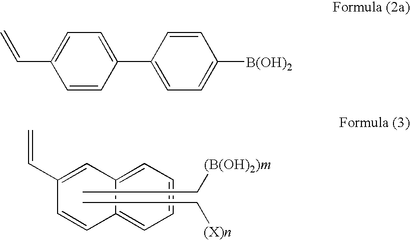

wherein each X independently is a further substituent as hereinbefore described, n is from 0 to 3 (preferably 0) and m is 1 or 2 (preferably 1).

A preferred monomer of Formula (3) is of the Formula (3a):

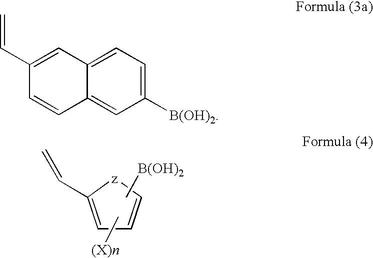

wherein Z is O, N or S (preferably S), each X independently is a further substituent as hereinbefore described and n is from 0 to 2 (preferably 0).

A preferred monomer of Formula (4) is of the Formula (4a):

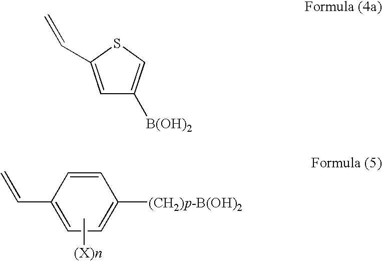

wherein p is from 1 to 30 (preferably from 1 to 10), each X independently is a further substituent as hereinbefore described and n is from 0 to 2 (preferably 0).

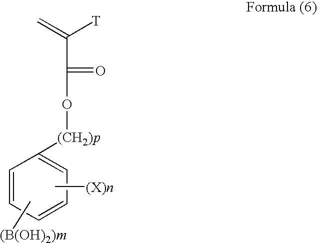

wherein T is H or methyl, p is 0 or 1 (preferably 1), each X independently is a further substituent as hereinbefore described, n is from 0 to 2 (preferably 0) and m is 1 or 2 (preferably 1).

A preferred monomer of Formula (6) is of the Formula (6a):

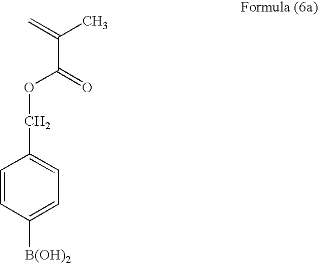

### Polymeric Dispersant Composition

According to a second aspect of the present invention there is provided a polymeric dispersant comprising:
i) 5 to 50 mole %, more preferably 15 to 50 mole % of repeat units from polymerising one or more hydrophilic ethylenically unsaturated monomers, all of which have no boronic acid groups;
ii) 20 to 80 mole %, more preferably 30 to 70 mole % of repeat units from polymerising one or more hydrophobic ethyleneically unsaturated monomers, all of which have no boronic acid groups;
iii) 1 to 50 mole %, more preferably 5 to 35 mole % of repeat units from polymerising one or more ethylenically unsaturated monomers each of which has one or more boronic acid group;
   wherein the sum of i)+ii)+iii) equals 100 mole %.

Where appropriate and where not inconsistent with the definition of the dispersant in the second aspect of the present invention all the parts of the description, definitions and preferences which relate to the dispersant as defined in the first aspect of the present invention relate equally and may be combined equally with the dispersant of the second aspect.

As previously mentioned it is preferred that the boronic acid monomers used in component iii) are all hydrophobic.

In a preferred embodiment the polymeric dispersant as a whole has a calculated Log P value of >=1, more preferably from 1 to 6, and especially from 1.5 to 4.

These dispersants have a particularly good combination of dispersant characteristics. For example, they facilitate easy aqueous milling of pigments to very small (<200 nm) average particle sizes. Also, the resulting aqueous dispersions are particularly stable. In addition, the reflectance optical density (RODs) and durability of the prints obtained from inks containing such dispersions are particularly good even when the substrate contains no fixing additives.

### Preparation of the Polymeric Dispersant

The polymeric dispersant may be made by any suitable means. A preferred method for making polymeric dispersants is free radical polymerisation of ethylenically unsaturated monomers, especially (meth)acrylates, vinyl monomer containing aromatic groups such as vinyl naphthalene and styrenic monomers. Suitable free radical polymerisation methods include but are not limited to suspension, emulsion, dispersion and preferably solution polymerisation.

### Preparation of the Aqueous Dispersion

It is preferred that at least some of the polymeric dispersant is adsorbed onto the surface of the pigment particles. More preferably, the pigment has been dispersed using the polymeric dispersant. It is especially preferred that the pigment has been dispersed in water using only the polymeric dispersants as hereinbefore described. In this way the only dispersant(s) adsorbed onto the pigment particles are those as hereinbefore described containing boronic acid groups. Dispersion can be effected by any suitable means including for example, stirring and blending of a mixture comprising pigment, dispersant and water. More preferably dispersion is effected by bead milling, treatment with ultrasound and/or microfluidizing.

In one embodiment the pigment is dispersed using a second dispersant having no boronic acid groups and then the polymeric dispersant as defined above is added to this dispersion. In this embodiment much of the polymeric dispersant containing boronic acid groups is not adsorbed onto the pigment particles. Instead, the pigment particles have the second dispersant (having no boronic acid groups) adsorbed onto their surface.

### Preferred Proportions for the Dispersion

Preferred aqueous dispersions comprise:
i) 30 to 99.8 parts, preferably 50 to 98 parts of an aqueous liquid medium;
ii) 0.1 to 30 parts, preferably 1 to 15 parts of the pigment particles;
iii) 0.1 to 30 parts, preferably 1 to 15 parts of the polymeric dispersant;
   wherein the parts are by weight and the sum of the parts i)+ii)+iii)=100.

### Applications

The aqueous dispersions of the present invention may be used to prepare tints and paints, but they are especially suited to the preparation of inks.

### Ink

Preferably, the ink has a viscosity of less than 50 mPa·s, more preferably less than 30 mPa·s and especially less than 15 mPa·s, when measured at a temperature of 25° C.

Preferably, the ink has a surface tension of 20 to 65 dynes/cm, more preferably 25 to 50 dynes/cm, when measured at a temperature of 25° C.

The ink may optionally contain additives. The ink additives may be of any of the additives suitable for use in inks, for example viscosity modifiers, pH buffers (e.g. 1:9 citric acid/sodium citrate) corrosion inhibitors, biocides, dyes, water, organic solvent(s) and/or kogation reducing additives.

Preferably, the ink prepared by the above process contains water and an organic liquid as hereinbefore described in a weight ratio of from 99:1 to 1:99, more preferably from 99:1 to 50:50 and especially from 95:5 to 70:30.

The pH of the ink is preferably from 4 to 11, more preferably from 7 to 10.

Preferably, the process used to make the ink includes a step to remove any particles having a particle size of more than 1 micron. This may be achieved using, for example, filtration and/or centrifugation.

Preferably, the ink contains from 0.1 to 30% by weight of pigment, more preferably from 1 to 10% by weight of pigment.

Preferably, the ink contains no dispersant which is free from boronic acid groups.

Preferably, the ink is suitable for use in ink jet printing ink.

According to a third aspect of the present invention there is provided an ink jet printing ink comprising an aqueous dispersion according to the first aspect of the present invention.

When the ink is used as an ink jet printing ink, the ink preferably has a concentration of halide ions of less than 500 parts per million, more preferably less than 100 parts per million. It is especially preferred that the ink has less than 100, more preferably less than 50 parts per million of divalent and trivalent metals. Parts per million as used above refers to parts by weight relative to the total weight of the ink. We have found that purifying the inks to reduce the concentration of these undesirable ions reduces nozzle blockage in ink jet printing heads, particularly in thermal ink jet printers. A preferred method for purifying the ink is ultrafiltration.

According to a fourth aspect of the present invention there is provided a process for printing an image on a substrate comprising applying an ink jet printing ink according to the third aspect of the present invention to the substrate by means of an ink jet printer.

The substrate may be a paper, a plastic film or a textile material. The substrate may have an ink jet printing ink receptor layer. We have found that particularly good print durability and ROD is obtained using an offset paper substrate. Offset paper is preferably non-porous, it may additionally be glossy.

Thus, according to a fifth aspect of the present invention there is provided the use of the process according to the fourth aspect of the present invention for obtaining an substrate printed with an ink jet printing ink for the technical purpose of achieving improved reflectance optical density and/or durability.

According to a sixth aspect of the present invention there is also provided an ink jet printer cartridge comprising a chamber and an ink jet printing ink, wherein the ink is present in the chamber and the ink is according to the third aspect of the present invention.

The present invention will now be further illustrated by the flowing non-limiting examples in which all amounts are by weight unless indicated otherwise:

### EXAMPLES

### 1. Polymeric Dispersant Synthesis

### 1.1 Preparation of Polymeric Dispersant Solution (1)

The ethylenically unsaturated monomers methacrylic acid (5.00 g, 58.1 mmoles), 2-ethylhexyl methacrylate (7.2 g, 36.3 mmoles) and 4-vinylphenylboronic acid (12.9 g, 87.1 mmoles) were mixed together along with a chain transfer agent butyl 3-mercaptopropionate (0.24 g, 1.5 mmoles). The mixture of ethylenically unsaturated monomers and the chain transfer agent were then dissolved in a liquid mixture of isopropyl alcohol (64 g) and dipropylene glycol (38.3 g) to give a 20% w/w solution which was charged into a reactor.

A thermal initiator, Trigonox™ 21S, (0.25 g) was then added to the reactor contents, and the contents were stirred continuously whilst the temperature was maintained at 85° C. for 4 hours. The reaction was performed using a nitrogen gas atmosphere throughout.

A second charge of thermal initiator, Trigonox™ 21S (0.25 g), was then added and the polymerisation was continued at a temperature of 85° C. for a further 4 hours, still using a nitrogen gas atmosphere. These steps polymerised the ethylenically unsaturated monomers to prepare Polymeric Dispersant (1) in the form of a dilute solution.

The reactor contents were then cooled to a temperature of 25° C., poured into a rotary evaporator and evaporated to concentrate the Polymeric Dispersant (1) to about 40% w/w. The molecular weights of the Polymeric Dispersant (1) as measured by gel permeation chromatography using a dimethyl formamide (DMF) solvent and polystyrene standards were Mn 64,000 and Mw 200,000. Thus, step 1.1 resulted in the preparation of Polymeric Dispersant solution (1).

### 1.2 Polymer Neutralisation

The Polymeric Dispersant solution (1) prepared in 1.1 above (64.14 g) was neutralised by the addition of potassium hydroxide aqueous solution 45% w/w (5.8 g). The resulting solution was adjusted to a solids content of 15% by weight by the addition of deionized water (204.4 g). This prepared Neutralised dispersant solution (1).

### 1.3 Preparation of Polymeric Dispersant Solution (2)

The ethylenically unsaturated monomers methacrylic acid (5.0 g, 58.1 mmoles), 2-ethylhexyl methacrylate (7.2 g, 36.3 mmoles), methyl methacrylate (7.3 g, 72.6 mmoles), and 4-vinylphenylboronic acid (2.1 g, 14.5 mmoles) were mixed together along with and a chain transfer agent butyl 3-mercaptopropionate (0.24 g, 1.5 mmoles). The mixture of ethylenically unsaturated monomers and the chain transfer agent the were then dissolved in a liquid mixture of isopropyl alcohol (55.2 g) and dipropylene glycol (33.1 g) to give a 20% w/w solution which was charged into a reactor.

A thermal initiator, Trigonox™ 21S, (0.22 g) was then added to the reactor contents, and the contents were stirred continuously whilst the temperature was maintained at 85° C. for 4 hours. The reaction was performed using a nitrogen gas atmosphere throughout.

A second charge of thermal initiator, Trigonox™ 21S (0.22 g), was then added and the polymerisation was continued at a temperature of 85° C. for a further 4 hours, still using a nitrogen gas atmosphere. These steps polymerised the ethylenically unsaturated monomers to prepare the Polymeric Dispersant (2) in the form of a dilute solution.

The reactor contents were then cooled to a temperature of 25° C., poured into a rotary evaporator and evaporated to concentrate the Polymeric Dispersant is (2) to about 40% w/w. The molecular weights of the Polymeric Dispersant (2) as measured by gel permeation chromatography using a DMF solvent and polystyrene standards were Mn 30,000 and Mw 50,000. Thus, step 1.3 resulted in the preparation of Polymeric Dispersant solution (2).

### 1.4 Polymer Neutralisation

The Polymeric Dispersant solution (2) prepared in 1.3 above (55.38 g) was neutralised by the addition of potassium hydroxide aqueous solution 45% w/w (5.8 g). The resulting solution was adjusted to a solids content of 10% by weight by the addition of deionized water (178 g). This prepared Neutralised dispersant solution (2).

### 2.1 Pigment Dispersion (1)

A pigment (Carbon black—Nipex® 170IQ obtained from Degussa®) (15 parts), was mixed with Neutralised dispersant solution (1) (60 parts) and deionized water (25 parts). The mixture was then stirred for several minutes to form a pre-dispersion. The pre-dispersion was then placed into a Branson Digital S450D Ultrasonifier fitted with a ½″ Tapped horn with a flat tip. The sample was cooled with an ice-bath and was dispersed at 60% amplitude for 60 mins. This prepared Pigment dispersion (1). The pigment particles in Pigment dispersion (1) had a MV average particle size of about 90 nm as measured by a Nanotrac® instrument.

### 2.2 Pigment Dispersion 2)

A pigment (Carbon black—Nipex® 170IQ obtained from Degussa® (15 parts), was mixed with Neutralised dispersant solution (2) (60 parts) and deionized water (25 parts). The mixture was then stirred for several minutes to form a pre-dispersion. The pre-dispersion was then placed into a Branson Digital S450D Ultrasonifier fitted with a ½′ Tapped horn with a flat tip. The sample was cooled with an ice-bath and was dispersed at 60% amplitude for 60 mins. This prepared Pigment dispersion (2). The pigment particles in Pigment dispersion (2) had a MV average particle size of about 90 nm as measured by a Nanotrac® instrument.

### 2.3 Pigment Dispersion (3)

A pigment (Pigment Red 122—TRM11® obtained from DNS) (15 parts), was mixed with Neutralised dispersant solution (2) (100 parts). The mixture was then stirred for several minutes to form a pre-dispersion. The pre-dispersion was then placed into a Branson Digital S450D Ultrasonifier fitted with a ½″ Tapped horn with a flat tip. The sample was cooled with an ice-bath and was dispersed at 60% amplitude for 150 mins. A small number of over-size particles were removed using a 0.1 um syringe filter. This prepared Pigment dispersion (3). The pigment particles in Pigment dispersion (3) had a MV average particle size of about 110 nm as measured by a Nanotrac® instrument.

### 2.4 Comparative Pigment Dispersion (1)

A comparative carbon black pigment dispersion (CAB-O-JET™ 300) was obtained from Cabot corp. CAB-O-JET™ 300 is a carboxylic acid functional, surface modified (unencapsulated) pigment dispersed in water. CAB-O-JET™ has no boronic acid groups. The pigment content was about 15% w/w.

2.5 Comparative Pigment Dispersion (2)

A comparative magenta pigment dispersion (containing Pigment Red 122—Chromophthal Jet Magenta DMQ® obtained from Ciba) was prepared according to the process outlined in JP 2007-277302A under the heading [0127].

20 parts of Pigment Red 122 was stirred with p-nonylphenylboronic acid (Obtained from Alfa Aesar, 2.1 parts), glycerin (10 parts), 2M sodium hydroxide solution (4.1 parts) and deionised water (67 parts) to form a pre-dispersion.

The pre-dispersion was then placed into a Branson Digital S450D Ultrasonifier fitted with a ½″ Tapped horn with a flat tip. The sample was cooled with an ice-bath and was dispersed at 30% amplitude using a pulsed exposure (1.0 s exposure, 0.5 s pause) for 10 hours.

The dispersion prepared in this fashion was too thick to filter and contained many oversized particles. Without filtering the pigment particles in Comparative pigment dispersion (2) had a D₉₀V average particle size of about 125 microns as measured by a Mastersizer® instrument. Similar results were obtained for a magenta pigment dispersion prepared as above using Pigment Red 122—TRM11 ® obtained from DNS. Thus, comparative pigment dispersion (2) could not be used to prepare a satisfactory ink jet printing ink since the particle size was too large for successful ejection through an ink jet printer nozzle.

### 3.1 Ink Vehicle (1)

Ink vehicle (1) was prepared by mixing 2-pyrrolidone (10.91 parts), glycerol (54.44 parts), 1,2-hexane diol (15.55 parts), ethylene glycol (18.18 parts) and Surfynol® 465 (1.82 parts obtained from Air Products).

### 4. Inks

### 4.1 Preparation of Inks (1)-(3)

Inks (1) to (3) were prepared by mixing the components described in Table 1. Ink vehicle (1) and deionized water were mixed together. This mixture was stirred whilst Pigment dispersions (1), (2) or (3) were added. The mixture was then placed into a sealed bottled and rolled on rollers for a period of 30 minutes.

TABLE 1

| Ink reference | Ink (1) | Ink (2) | Ink (3) |
|---|---|---|---|
| Ink vehicle (1) | 27.5 | 27.5 | 27.5 |
| Deionized water | 32.5 | 32.5 | 32.5 |
| Pigment dispersion (1) | 40.0 | | |
| Pigment dispersion (2) | | 40.0 | |
| Pigment dispersion (3) | | | 40.0 |

### 4.2 Preparation of Comparative Ink (1)

Comparative ink (1) was prepared by mixing the components described in Table 2. Ink vehicle (1) and deionized water were mixed together. This mixture was stirred whilst Comparative Pigment dispersion (1) was added. The mixture was then placed into a sealed bottled and rolled on rollers for a period of 30 minutes.

TABLE 2

| Ink reference | Comparative Ink (1) |
|---|---|
| Ink vehicle (1) | 27.5 |
| Deionized water | 45.83 |
| Comparative | 26.68 |
| Pigment dispersion (1) | |

### 5. Preparation of Striped Test Samples

The above prepared Inks and the Comparative ink were applied to HP advanced IJ paper using the following method:
i) 100 micro litres of the ink were accurately pipetted onto the surface of the paper;
ii) the ink was then drawn down uniformly over the surface of the paper using a K-control K-bar (No 1, 6 microns wet film) this step provided a stripe of ink on the paper;
iii) the ink was then allowed to dry on the paper for a period of 24 hours.

This prepared Test samples (1) to (3) and Comparative test sample (1). The references corresponding exactly to the Inks and Comparative inks which were deposited on the paper.

### 6. Testing Methods

### 6.1 Highlighter Durability

Highlighter durability was tested by highlighting twice across the same part of the test samples. Each of the two highlighter passes were started about 2.5 cm into the striped region (where the Ink or Comparative ink had been applied) and was continued in a straight line to approximately 2.5 cm outside the stripe (into a region in which no Ink or Comparative ink had been applied).

Two different kinds of highlighter pen mimics were used in the above durability tests. Each pen mimic comprised a HPLC vial filled with one of two highlighter pen inks and fitted with a 4.6 mm wide fibre nib purchased from Teibow Co Ltd.

The alkaline highlighter pen mimic contained an alkaline highlighter ink which contained 20% sucrose, 0.2% Proxel® GXL and adjusted to a pH of 10.5 with NaOH, the remaining amounts required to make 100% were made up with deionized water.

The acidic highlighter pen mimic contained an acidic highlighter ink which contained 20% glycerol, 0.2% Proxel® CXL, adjusted to a pH of 5 with acetic acid, the remaining amounts required to make 100% were made up with deionized water.

### 6.2 Wet Rub Durability

A nitrile rubber medical examination glove was worn on the hand and the index finger of the glove was wetted with deionized water. Excess water was gently shaken off. The index finger was then used to rub the stripe starting from about 2.5 cm into the stripe and continuing in a straight line to approximately 2.5 cm outside the stripe. The rub was repeated three times in the same part of the stripe/paper.

### 6.3 Measurement of Durability

In both the highlighter and wet-rub durability tests any pigment which moved from the initial striped region to the region where no ink or comparative ink had been applied gave rise to a darkened or smeared appearance in the region where no ink had been applied.

The amount of smearing was quantified visually wherein:

5=no smearing visible

4=slight smearing

3=significant smearing

2=extensive smearing

1=intense/dramatic smearing

In addition a Gretag Macbeth Spectrolino photodensitometer was used to measure the reflectance optical density (ROD) of the region where smearing might appear after the durability test. The ROD value used was an average of 12 measurements (4 measurements on each test, each test being performed 3 times in total). Of course, lower values for the ROD correspond to less smearing and therefore better durability performance.

For all of the durability results an improvement factor was calculated by dividing the highest ROD obtained (that for the comparative ink samples) by the ROD of the ink in question. Higher improvement factors equate to better durability and less smear.

### 7. Results

### 7.1 Inks and Comparative Inks

TABLE 3

| | | Wet rub | |
|---|---|---|---|
| Ink on the test | Wet rub ROD | improvement | Wet rub |
| sample | after test | factor | visual score |
| Comparative Ink (1) | 0.285 | 1 | 1 |
| Ink (1) | 0.100 | 2.9 | 4 |
| Ink (2) | 0.164 | 1.7 | 4 |
| Ink (3) | 0.104 | — | 5 |

Table 3, shows inks containing aqueous dispersions of the present invention provided a much improved wet-rub durability when compared to comparative inks based on a surface modified pigment which do not contain a polymeric dispersant having boronic acid groups. The wet rub improvement factor for Ink (3) could not be calculated because Comparative Ink (2) could not be printed.

TABLE 4

| | | Alkaline | |
|---|---|---|---|
| | Alkaline | highlighter | Alkaline |
| | highlighter | mimic | highlighter |
| Ink on the test | mimic | improvement | mimic |
| sample | ROD after test | factor | visual score |
| Comparative Ink (1) | 0.161 | 1 | 2 |
| Ink (1) | 0.09 | 1.8 | 4 |
| Ink (2) | 0.131 | 1.2 | 4 |
| Ink (3) | 0.089 | — | 5 |

Table 4, shows that inks containing aqueous dispersions of the present invention provided a much improved alkaline highlighter durability when compared to comparative inks based on surface modified pigments which do not contain the polymeric dispersant having boronic acid groups. The alkaline highlighter improvement factor for Ink (3) could not be calculated because Comparative Ink (2) could not be printed.

TABLE 5

| | | Acidic | Acidic | |
|---|---|---|---|---|
| | | highlighter | highlighter | Acidic |
| | | mimic | mimic | highlighter |
| Ink on the | Pigment | ROD after | improvement | mimic |
| test sample | type | test | factor | visual score |
| Comparative | SM | 0.285 | 1 | 1 |
| Ink (1) | | | | |
| Ink (1) | E | 0.11 | 2.6 | 4 |
| Ink (2) | E | 0.11 | 2.6 | 4 |
| Ink (3) | E | 0.081 | — | 5 |

Table 5, shows that inks containing aqueous dispersions of the present invention provided a much improved acidic highlighter durability when compared to equivalent inks based on surface modified pigments which do not contain the polymeric dispersant having boronic acid groups. The acidic highlighter improvement factor for Ink (3) could not be calculated because Comparative Ink (2) could not be printed.

We have obtained similar results to those shown above using HP Colorlok, Xerox 4200, 4CC art and Epson Crispia IJ paper.

The above findings clearly demonstrated the improvements in wet rub, alkaline and acidic highlighter durability obtained from inks containing aqueous dispersions according to the present invention.

### 8. Further Inks

The further inks described in Tables I & II may be prepared wherein Pigments dispersions (PD 1-3) are as defined above and the ink additives are as defined below. Numbers quoted in the second column onwards refer to the number of parts of the relevant ingredient and all parts are by weight. The inks may be applied to paper by thermal, piezo or Memjet ink jet printing.

The following abbreviations are used in Table I & II:

PG=propylene glycol

DEG=diethylene glycol

NMP=N-methyl pyrrolidone

DMK=dimethylketone

PA=isopropanol

MEOH=methanol

2P=2-pyrrolidone

MIBK=methylisobutyl ketone

P12=propane-1,2-diol

BDL=butane-2,3-diol

Surf=Surfynol™ 465 from Airproducts

PHO=Na₂HPO₄ and

TBT=tertiary butanol

TDG=thiodiglycol

GLY=Glycerol

nBDPG=mono-n-butyl ether of dipropylene glycol

nBDEG=mono-n-butyl ether of diethylene glycol

nBTEG=mono-n-butyl ether of triethylene glycol

PD=Pigment dispersion

TABLE I

| | PD | | | | | | | Na | | | | | | |
|---|---|---|---|---|---|---|---|---|---|---|---|---|---|---|
| PD | content | Water | PG | DEG | NMP | DMK | NaOH | Stearate | IPA | MEOH | 2P | MIBK | GLY | nBDPG |
| 1 | 30 | 50 | 5 | | 6 | 3 | | | | | 5 | | 1 | |
| 1 | 30 | 59.8 | | 5 | 5 | | 0.2 | | | | | | | |
| 1 | 40 | 45 | 3 | | 3 | 3 | | | | 5 | 1 | | | |
| 1 | 40 | 51 | | 8 | | | | | | | | 1 | | |
| 1 | 40 | 45.8 | 5 | | | | | 0.2 | 4 | | | 5 | | |
| 1 | 40 | 41 | | | 9 | | 0.5 | 0.5 | | | 9 | | | |
| 1 | 40 | 10 | 4 | 15 | 3 | 3 | | | 6 | 10 | 5 | 4 | | |
| 1 | 40 | 30 | | 20 | | | | | 9 | | | | | 1 |
| 1 | 50 | 25 | 5 | 4 | | 5 | | | | 6 | | 5 | | |
| 1 | 50 | 29.7 | 3 | 5 | 2 | 10 | | 0.3 | | | | | | |
| 2 | 50 | 15 | | 5 | 4 | 6 | | | 5 | 4 | 6 | 5 | | |
| 2 | 50 | 46 | | | | | | | | 4 | | | | |
| 2 | 40 | 50 | 5 | | | | | | 5 | | | | | |
| 2 | 40 | 40 | 2 | 6 | 2 | 5 | | | 1 | | 4 | | | |
| 2 | 40 | 40 | | 5 | | | | | | | 15 | | | |
| 2 | 40 | 44 | | | 11 | | | | | | 5 | | | |
| 2 | 50 | 30 | 2 | | | 10 | | | | 2 | | 6 | | |
| 2 | 50 | 39.7 | | | | 7 | 0.3 | | 3 | | | | | |
| 3 | 40 | 29 | 2 | 20 | 2 | 1 | | | | | 3 | 3 | | |
| 3 | 40 | 51 | | | 4 | | | | | | 5 | | | |
| 3 | 40 | 40 | | | | | | | | | | | 20 | |
| 3 | 40 | 40 | | | | | | | | | | | | 20 |

TABLE II

| | PD | | | | | | | | | | | | | |
|---|---|---|---|---|---|---|---|---|---|---|---|---|---|---|
| PD | Content | Water | PG | DEG | NMP | Surf | TBT | TDG | BDL | PHO | 2P | PI2 | nBDEG | nBTEG |
| 3 | 30 | 49.8 | 15 | | | 0.2 | | | | | 5 | | | |
| 3 | 30 | 58.8 | | 5 | | | | | | 1.2 | | 5 | | |
| 3 | 40 | 44.65 | 5 | 5 | | 0.1 | 4 | 0.2 | | | | | | 1 |
| 3 | 40 | 49.88 | | 6 | 4 | 5 | | | | 0.12 | | | | |
| 3 | 40 | 41.7 | 4 | 8 | | | | | | | | 6 | | |
| 1 | 40 | 44.8 | | 10 | | 0.3 | | | 5 | 0.2 | | | | |
| 1 | 50 | 39.7 | | 5 | 5 | | | 0.3 | | | | | | |
| 1 | 50 | 20 | | 10 | 4 | | | | 1 | | 4 | 11 | | |
| 1 | 40 | 35 | 4 | 10 | 3 | | | | 2 | | 6 | | | |
| 1 | 40 | 51 | | | 6 | | | | | | 3 | | | |
| 1 | 40 | 35.05 | | 9 | 7 | | 2 | | | 0.95 | 5 | | 1 | |
| 1 | 40 | 38 | 5 | 11 | | | | | | | 6 | | | |
| 2 | 50 | 36 | | | 7 | | | | | | 7 | | | |
| 2 | 50 | 24.5 | 5 | 5 | 4.1 | | 0.2 | 0.1 | 5 | 0.1 | 5 | | | |
| 2 | 40 | 50 | | 10 | | 1 | | | | | | | | |
| 2 | 40 | 50 | | | | | | 10 | | | | | | |
| 2 | 30 | 48 | | | 5 | | | 12 | | | 5 | | | |
| 2 | 30 | 40 | 2 | | 8 | | | 15 | | | 5 | | | |
| 2 | 40 | 40 | | | | | | 8 | | | 12 | | | |
| 2 | 40 | 40 | | 10 | | | | | | | | | 10 | |
| 2 | 40 | 40 | | | | | | | | | 10 | | | 10 |

1. An aqueous dispersion comprising water, pigment particles and a polymeric dispersant comprising monomer repeat units from polymerising one or more ethylenically unsaturated monomers, said dispersant having one or more boronic acid groups.

2. An aqueous dispersion according to claim 1 wherein the polymeric dispersant comprises one or more repeat units from polymerising ethylenically unsaturated monomers selected from acrylic, methacrylic and styrenic monomers.

3. An aqueous dispersion according to claim 1 wherein each boronic acid group is directly bonded to a carbon atom in an aromatic group present in the polymeric dispersant structure.

4. An aqueous dispersion according to claim 1 wherein the polymeric dispersant has a number averaged molecular weight of from 1,000 to 50,000.

5. An aqueous dispersion according to claim 1 wherein the polymeric dispersant has phenyl boronic acid groups.

6. An aqueous dispersion according to claim 1 wherein the polymeric dispersant has acid groups, other than boronic acid, which are in the form of the free acid or a salt.

7. An aqueous dispersion according to claim 6 wherein the polymeric dispersant has a ratio of moles of acid groups other than boronic acid to boronic acid groups of from 10:1 to 1:5.

8. An aqueous dispersion according to claim 1 wherein the polymeric dispersant comprises:
i) 5 to 50 mole % of repeat units from polymerising one or more hydrophilic ethylenically unsaturated monomers, all of which have no boronic acid groups;
ii) 20 to 80 mole % of repeat units from polymerising one or more hydrophobic ethylenically unsaturated monomers, all of which have no boronic acid groups;
iii) 1 to 50 mole % of repeat units from polymerising one or more ethylenically unsaturated monomers each of which has one or more boronic acid group;
wherein the sum of i)+ii)+iii) equals 100 mole %.

9. An aqueous dispersion according to claim 1 wherein the polymeric dispersant is cross-linked around the pigment particles so as to encapsulate each pigment particle.

10. An ink jet printing ink containing an aqueous dispersion according to claim 1.

11. A process for printing an image on a substrate comprising applying an ink jet printing ink according to claim 10 to the substrate by means of an ink jet printer.

12. A process according to claim 11 wherein the substrate is an offset paper.

13. An ink jet printer cartridge comprising a chamber and an ink jet printing ink, wherein the ink is present in the chamber and the ink is according to claim 10.

14. Use of the process according to claim 11 or 12 for obtaining a substrate printed with an ink jet printing ink for the technical purpose of achieving improved reflectance optical density and/or durability.

15. A polymeric dispersant comprising:
i) 5 to 50 mole % of repeat units from polymerising one or more hydrophilic ethylenically unsaturated monomers, all of which have no boronic acid groups;
ii) 20 to 80 mole % of repeat units from polymerising one or more hydrophobic ethylenically unsaturated monomers, all of which have no boronic acid groups;
iii) 1 to 50 mole % of repeat units from polymerising one or more ethylenically unsaturated monomers each of which has one or more boronic acid group;
wherein the sum of i)+ii)+iii) equals 100 mole %.
